(19) United States
(12) Patent Application Publication
(10) Pub. No.: US 2016/0023170 A1
(43) Pub. Date: Jan. 28, 2016

(54) POLYVINYLIDENE FLUORIDE HOLLOW FIBER MEMBRANES AND PREPARATION THEREOF

(71) Applicants: H2L CO., LTD., Anyang-si (KR); H2L ENGINEERING.CO.,LTD., Anyang-si (KR)

(72) Inventors: Ik Bae Yang, Uiwang-si (KR); Sung Ro Yoon, Seongnam-si (KR); Yong Ho Choi, Suwon-si (KR); Se Mi Kim, Ansan-si (KR)

(73) Assignees: H2L CO., LTD., Anyang-si (KR); H2L ENGINEERING, CO., LTD, Anyang-si (KR)

(21) Appl. No.: 14/775,014

(22) PCT Filed: Jun. 26, 2013
(86) PCT No.: PCT/KR2013/005645

§ 371 Date: Sep. 11, 2015

(30) Foreign Application Priority Data
Mar. 14, 2013 (KR) 10-2013-0027254

(51) Int. Cl. B01D 71/78; B01D 61/18; B29C 47/00; B01D 71/38; B01D 71/40; B01D 69/08; B01D 71/34

(52) U.S. Cl. CPC B01D 71/78; B01D 69/081; B01D 69/087; B01D 61/18; B01D 71/34; B01D 71/38; B01D 71/40; B29C 47/0004; B01D 2323/38; B01D 2325/02; B01D 2325/04; B01D 2325/34; B01D 2325/20; B01D 2325/38; B29K 2027/16

(57) ABSTRACT

Disclosed are polyvinylidene fluoride hollow fiber separation membranes and a preparation method thereof, and more particularly, to polyvinylidene fluoride hollow fiber separation membranes, which may be usefully used not only for water treatment, but also in the sewage treatment field, such as domestic waste water, industrial wastewater, or the like because the polyvinylidene fluoride hollow fiber separation membranes possess excellent pure water permeability and chemical resistance such as alkali resistance, etc., when applied as a separation membrane due to excellent alkali resistance while significantly improving hydrophobicity due to an amphoteric substance, which is a disadvantage of the PVDF hollow fiber separation membranes, by preparing a (PVDF) hollow fiber separation membrane with a thermosetting resin in which the amphoteric substance, in which hydrophilic groups and hydrophobic groups are constituted in the form of a covalent bond, has been introduced into a polyvinylidene fluoride (PVDF)-based resin, and a preparation method thereof.

### TECHNICAL FIELD

The present invention relates to polyvinylidene fluoride hollow fiber separation membranes and a preparation method thereof, and more particularly, to polyvinylidene fluoride hollow fiber separation membranes, which may be usefully used not only for water treatment, but also in the sewage treatment field, such as domestic waste water, industrial wastewater, or the like because the polyvinylidene fluoride hollow fiber separation membranes possess excellent pure water permeability and chemical resistance such as alkali resistance, etc., when applied as a separation membrane due to excellent alkali resistance while significantly improving hydrophobicity due to an amphoteric substance, which is a disadvantage of the PVDF hollow fiber separation membranes, by preparing a polyvinylidene fluoride (PVDF) hollow fiber separation membrane with a thermosetting resin in which the amphoteric substance in which hydrophilic groups and hydrophobic groups are constituted in the form of a covalent bond has been introduced into a polyvinylidene fluoride (PVDF)-based resin, and a preparation method thereof.

### BACKGROUND ART

As a polymer material that is mainly used in preparing an ultrafiltration or microfiltration hollow fiber membrane that is used for various water treatments or treatment of waste water or sewage, polysulfone (PSf), polyethersulfone (PES), polyvinylidene fluoride (PVDF), polyethylene, polypropylene (PP), polytetrafluoroethylene (PTFE), polycarbonate (PC), polyamide (PA), polyester, polyvinylchloride (PVC), cellulosenitrate, regenerated cellulose, celluloseacetate (CA), cellulosetriacetate (CTA), polyacrylonitrile (PAN), etc., are used.

Polysulfone (PSf), polyethersulfone (PES), and polyvinylidene fluoride (PVDF) are a hydrophobic material and mainly used in preparing an ultrafiltration membrane or a microfiltration hollow fiber membrane using a phase transition method. However, polysulfone or polyethersulfone has a much faster phase transition rate and a lower viscosity than polyvinylidene fluoride, and thus a large number of hollow fiber membranes may be prepared within a short period of time. Nevertheless, the membrane surface is easily damaged or cut off due to weak mechanical strength, a separation membrane rapidly deteriorates when used for a long time due to low chemical resistance, and there is a problem when the membrane is used for a long period of time due to membrane contamination because the membrane has relatively large pores. Further, the permeation speed is large, but there is a problem in that the contamination phenomenon of the membrane is severe and the passage of fine organic materials is caused.

Polyethylene or polypropylene is a representative crystalline polymer, and has very high porosity by usually melting a polymer to perform extrusion spinning, and then tearing a non-crystalline region, which is present between crystals and crystals by stretching, to form pores. Therefore, a hollow fiber membrane prepared by this method has a high permeation flux, but has slit-shaped pores and a relatively large pore and pore distribution, thereby making it difficult to control membrane contamination, and has a limitation in separation performance, and thus there is a problem in that the hollow fiber membrane is used in treatment of sewage, waste water, or the like with extreme limitation.

A polycarbonate or polyester material is prepared as a separation membrane using a track etching method due to the characteristic of the material, but there is an advantage in that uniform pores may be prepared by the method, but there is a problem in that the method is limited to a microfiltration membrane with an extremely low porosity and large pores, and it is difficult to mass-produce a separation membrane by the method.

A polymer, such as cellulose nitrate, regenerated cellulose, celluloseacetate (CA), cellulosetriacetate (CTA), polyacrylonitrile (PAN), etc., is a relatively hydrophobic polymer, a separation membrane is prepared from the polymer using a solvent-induced phase transition method, and the polymer has a high permeation flux. However, there is a problem in that the polymer has a weak chemical resistance and durability, and thus the polymer has a problem when used for a long time due to easy rupture or damage when molded as a hollow fiber membrane.

As a PVDF hollow fiber membrane known in the related art, Korean Patent Application Publication No. 2005-0056245 discloses the formation of a hydrophilized membrane by a method of inducing the production of radicals of a hydrophilic vinyl monomer using irradiation of ionizing radiation on a PVDF-based microporous membrane in order to impart a hydrophilic function to a PVDF hollow fiber separation membrane, and then graft polymerizing these radicals on the membrane surface.

In addition, Korean Patent Application Publication No. 2006-0003347 discloses a porous membrane of a hydrophilized PVDF-based resin that is prepared by copolymerizing a hydrophilic monomer, which contains an epoxy group, a hydroxy group, a carboxy group, an ester group, and an amide group, with a polyvinylidene fluoride monomer through suspension polymerization.

Recently, Korean Patent No. 1036312 discloses a hollow fiber separation membrane which is a PVDF-based hollow fiber separation membrane, in which piles of a plurality of irregular aggregate forms are connected with each other inside the separation membrane, gaps split between piles and piles have an average length from 1 μm to 100 μm, a support layer in the form of aggregates having an amorphous structure that has macropores having an average width from 0.1 μm to 10 μm, which is formed by a thermally-induced phase separation method, is formed, and a branch-type structure layer and a separation active layer are sequentially formed on the support layer.

Furthermore, preparation examples of a nanocomposite hollow fiber membrane that contains a porous membrane having both a 3-D mesh structure and a spheroidal structure or a hydrophilized organic clay, etc., have been proposed, and preparation examples of a porous membrane of a hydrophilized PVDF-based resin through a chemical treatment using alkali and an oxidant have also been suggested.

However, an additional process such as polymerization, a high-cost process such as the use of radiation, etc., are used in the related art technology, and particularly, a chemical treatment method has a defect that may frequently damage an inherent mechanical strength of the PVDF resin. Further, the PVDF fluorine-based polymer resin has relatively excellent processability, but has low resistance to alkali compared to other fluorine-based polymers, and thus it is difficult to use a PVDF resin as a porous membrane material that involves washing in alkali and may endure the use for a long time.

As an example of a porous membrane using a PVDF resin, Japanese Patent No. 1988180 discloses a method of preparing a PVDF hollow fiber membrane that is appropriate as a dialysis membrane, but a hollow fiber membrane made of a PVDF prepared by the preparation method according to the invention has not only a weak physical strength, but also a low water permeability and thus is not appropriate for the use that requires high water permeability and pressure resistance (durability).

In order to maintain the physical strength of the PVDF hollow fiber membrane, a method of embedding fibers in the thickness portion of the hollow fiber membrane is also suggested, but it is expected that it is difficult to exactly embed fibers in the thickness portion of the membrane by the method, and furthermore, exposure of fibers to the membrane surface leads to defect of the membrane, and thus it has been pointed out as a problem that the method is inappropriate for filtration of drinking water which requires high integrity.

As described above, a PVDF-based hollow fiber membrane in the related art exhibits some excellent physical properties as a hollow fiber membrane due to the material characteristics thereof, but it is difficult to prepare a hollow fiber membrane that has excellent durability or permeability, hydrophilicity, alkali resistance, etc., and thus there is a need for a technology that prepares a more improved hollow fiber membrane.

### CITATION LIST

### Patent Document

(Patent Document 1) 1. Korean Patent Application Publication No. 2005-0056245

(Patent Document 2) 2. Korean Patent Application Publication No. 2006-0003347

(Patent Document 3) 3. Korean Patent No. 1036312

(Patent Document 4) 4. Japanese Patent No. 1988180

### SUMMARY OF INVENTION

### Technical Problem

Thus, the present inventors have studied for a long time to resolve or improve the problem of a hollow fiber separation membrane for water treatment, which uses a PVDF resin in the related art, and as a result, found that when a PVDF hollow fiber membrane is prepared using a thermoplastic resin in which an amphoteric substance in which hydrophilic groups and hydrophobic groups are constituted in the form of a covalent bond has been introduced into a polyvinylidene fluoride (PVDF)-based resin, it is possible to prepare a PVDF hollow fiber separation membrane that has significantly improved hydrophilicity and excellent alkali resistance as a result of performing an experiment for a long time, thereby completing the present invention.

Therefore, an object of the present invention is to provide an improved PVDF hollow fiber separation membrane in which excellent physical properties are maintained for a long time by introducing a specific material into a PVDF resin.

Further, another object of the present invention is to provide a PVDF hollow fiber separation membrane that has excellent hydrophilicity and alkali resistance.

In addition, a yet another object of the present invention is to provide a method of preparing a PVDF hollow fiber separation membrane which is simple and has economically excellent physical properties by introducing an amphoteric substance, which has hydrophilic groups and hydrophobic groups, into a PVDF resin.

### Solution to Problem

In order to solve the above-described problem, the present invention provides a polyvinylidene fluoride (PVDF) hollow fiber separation membrane that consists of a thermoplastic resin, which contains from 2 to 50 parts by weight of one or more selected from polyethylene glycol-methacrylate-based and polyvinylpyrrolidone-methacrylate-based amphiphilicopolymers and having a weight average molecular weight from 10,000 to 200,000 based on 100 parts by weight of a PVDF resin, and has a porous hollow fiber structure.

Furthermore, the present invention provides a method of preparing a PVDF hollow fiber separation membrane, including: preparing a spinning solution by using a thermoplastic resin that includes from 2 to 50 parts by weight of one or more selected from polyethylene glycol-methacrylate-based and polyvinylpyrrolidone-methacrylate-based amphiphilic polymers and having a weight average molecular weight from 10,000 to 200,000, based on 100 parts by weight of a PVDF resin; spinning the spinning solution through a nozzle for preparing a hollow fiber; and preparing a porous hollow fiber by subjecting the spinning solution to a coagulation process.

### Advantageous Effects of Invention

A hollow fiber separation membrane using the PVDF resin prepared by the present invention has an effect of achieving excellent water permeability and making weak alkali resistance of the PVDF hollow fiber membrane excellent by introducing a hydrophilically complicated amphiphilic polymer, in which hydrophilic groups and hydrophobic groups are constituted in the form of a covalent bond, into a PVDF resin to improve hydrophilicity of the PVDF resin.

In particular, the PVDF hollow fiber separation membrane of the present invention has excellent hydrophilicity and alkali resistance and thus has an effect that various physical properties such as an inherent permeation effect, etc., are retained even though the separation membrane is used for a long time, and thus the separation membrane may be used for a long time.

Further, since it is possible to simply obtain an effect of improving physical properties by introducing the amphiphilic polymer, the preparation method thereof is simpler and more economical than a method of improving physical properties by a post-treatment. Therefore, the hollow fiber membrane of the present invention has excellent effects in terms of productivity and economic efficiency, compared to the existing hollow fiber membrane.

As an exemplary embodiment, when an asymmetrical hollow fiber separation membrane is prepared by the method exemplified in the present invention, the hollow fiber separation membrane of the present invention maintains high strength while having a high rejection ratio together with the aforementioned effects and thus may be used for various uses, such as a separation membrane module for water purification treatment, a separation membrane module for heavy water treatment, a submerged separation membrane module for a biofilm reactor, a module for separation of a chemical mixture, a pretreatment separation module for seawater desalination, etc., and the hollow fiber separation membrane of the present invention exhibits high economic efficiency and treatment performance, and further, modification or deterioration does not occur even though the hollow fiber separation membrane of the present invention is used for a long time, and thus it is possible to apply the hollow fiber separation membrane of the present invention to a next-generation high efficiency separation process.

### BEST MODE FOR CARRYING OUT THE INVENTION

Hereinafter, an exemplary embodiment of the present invention will be described in detail as follows.

The present invention relates to a PVDF hollow fiber separation membrane which is allowed to have an effect of improving physical properties when a porous hollow fiber membrane is prepared by introducing an amphiphilic polymer into a PVDF resin and thus has excellent hydrophilicity (water permeability) and alkali resistance due to the material compared to the hollow fiber membrane in the related art.

In preparing the improved PVDF hollow fiber separation membrane in the present invention, it is possible to prepare a PVDF hollow fiber separation membrane that has excellent characteristics without a post-treatment by directly preparing a porous hollow fiber structure that has excellent physical properties using a thermoplastic resin in which an amphiphilic polymer, which simultaneously has hydrophilicity and hydrophobicity, has been directly introduced into the PVDF resin during the process of preparing the hollow fiber without applying a method of improving physical properties by a separate post-treatment after the membrane is prepared, in order to improve the drawback of the PVDF-based hollow fiber membrane.

The PVDF hollow fiber separation membrane according to the present invention consists of a thermoplastic resin that contains from 2 to 50 parts by weight of one or more selected from polyethylene glycol-methacrylate-based and polyvinylpyrrolidone-methacrylate-based amphiphilic polymers and having a weight average molecular weight from 10,000 to 200,000, based on 100 parts by weight of a PVDF resin.

The PVDF resin that is used as a main raw material in the present invention includes preferably a copolymerization polymer that contains 30 mole % or more of a vinylidene fluoride homopolymer or vinylidene fluoride, and it is more preferred that a PVDF homopolymer is used in terms of enhancing durability. When the PVDF resin is a copolymerization polymer, another copolymerization monomer that is copolymerized with vinylidene fluoride may be appropriately selected from the monomers known in the art, and the monomer is not particularly limited, but preferably, a fluorine-based monomer, a chlorine-based monomer, or the like may be appropriately used.

In addition, the PVDF resin used in the present invention has a weight average molecular weight (Mw) preferably from 20,000 to 1,000,000, more preferably from 150,000 to 700,000, and most preferably from 50,000 to 500,000. When a weight average molecular weight Mw of the PVDF resin used in the present invention is less than 20,000, there is a problem in that the hollow fiber membrane prepared has a reduced strength, and when the weight average molecular weight thereof exceeds 1,000,000, there is a problem in that the productivity decreases during the film formation.

The PVDF hollow fiber separation membrane according to the present invention is prepared of a thermoplastic resin in which a hydrophilically complicated and specific amphiphilic polymer, in which hydrophilic groups and hydrophobic groups are constituted in the form of a covalent bond, has been introduced into the PVDF resin. Since in a hollow fiber membrane prepared by directly introducing the amphiphilic polymer into the PVDF resin during the preparation process, hydrophilicity on the surface thereof is increased to significantly enhance a pure water permeation rate, and since a water-molecule layer is easily formed on the membrane surface when the hollow fiber membrane is in contact with an aqueous solution, the contact frequency of the polymer component, which constitutes a porous membrane, with a cleaning reagent is reduced by the water-molecule layer formed on the surface of the hollow fiber membrane, thereby enhancing chemical resistance of the hollow fiber separation membrane, in particular, alkali resistance.

Any amphiphilic polymer may be used as the amphiphilic polymer used in the present invention as long as the amphiphilic polymer has affinity for water while having compatibility with PVDF-based resins, but it is preferred that an amphiphilic polymer having a weight average molecular weight (Mw) from 10,000 to 200,000 is used as a preferred amphiphilic polymer in order to implement a predetermined pore structure. When the weight average molecular weight is too small, it is difficult to form pores, and thus there is a problem in that pure water permeability deteriorates, and when the weight average molecular weight exceeds 200,000, various physical properties, such as durability, a rejection ratio, or the like, deteriorate due to the extreme formation of pores, etc., which is not preferred.

According to the present invention, one or more selected from polyethylene glycol-methacrylate-based and polyvinylpyrrolidone-methacrylate-based amphiphilic polymers may be preferably used as the amphiphilic polymer. More preferably, a solution, in which polyethylene glycol-methacrylate-based and polyvinylpyrrolidone-methacrylate-based amphiphilic polymers are mixed, may be used.

The amount of the amphiphilic polymer of the present invention introduced is preferably 2 to 50 parts by weight based on 100 parts by weight of the PVDF-based resin. When the content of the amphiphilic polymer is less than 2 parts by weight, it is difficult to implement the pore structure, and when the content thereof exceeds 50 parts by weight, the strength of the hollow fiber separation membrane is reduced, and thus it is preferred that the amphiphilic polymer is introduced within the range. Most preferably, the polyethylene glycol-methacrylate-based and polyvinylpyrrolidone-methacrylate-based amphiphilic polymers may be mixed in an amount of 2 to 15 wt %, respectively, and the mixture may be used in forming a hollow fiber separation membrane that has excellent hydrophilicity and alkali resistance, and excellent mechanical properties or durability.

According to the present invention, as described above, a hollow fiber separation membrane may be prepared by a preparation method including mixing amphiphilic polymers with a PVDF resin and dissolving the mixture in a solvent to prepare a spinning solution, spinning the spinning solution through a nozzle, and preparing a porous hollow fiber through a coagulation process.

As an exemplary embodiment of the present invention, a method of preparing a hollow fiber membrane will be described as follows.

According to a preferred example of the present invention, the present invention provides a method of preparing a PVDF hollow fiber separation membrane, the method including mixing the amphiphilic polymers in an amount from 2 to 50 parts by weight, respectively, based on 100 parts by weight of the PVDF resin to prepare a thermoplastic resin, preparing a spinning solution using the thermoplastic resin, discharging an internal coagulant (hollow forming agent) therein from a triple nozzle, discharging a good solvent at a temperature of 50° C. or less externally, and discharging the spinning solution from a nozzle between the inside and the outside.

According to another example thereof, the present invention provides a method of preparing a PVDF hollow fiber separation membrane, the method including: mixing the amphiphilic polymers in an amount from 2 to 50 parts by weight based on 100 parts by weight of the PVDF resin to prepare a thermoplastic resin, preparing a spinning solution using the thermoplastic resin, discharging an internal coagulant (hollow forming agent) therein from a dual nozzle, discharging the spinning solution externally to be coagulated, continuously allowing the spinning solution to pass through a good solvent, and then allowing the spinning solution to pass through a non-solvent.

The hollow fiber separation membrane prepared by the method preferably has a support layer with an amorphous structure having macropores specifically formed inside the separation membrane, and a branch-type structure layer and a separation active layer, which have been prepared by a non-solvent induced phase separation method, are sequentially formed on the support layer.

Here, the support layer is formed inside the hollow fiber separation membrane so as to support the hollow fiber separation membrane, and is not particularly limited as long as the support layer has the aforementioned purpose. However, the support layer preferably has an amorphous structure having macropores, and more preferably an aggregate form formed by a thermally-induced phase separation method or a modified thermally-induced phase separation method.

At this time, the amorphous structure having macropores is a pore structure in which piles of a plurality of irregular aggregate forms are connected with each other and gaps split between piles and piles are much larger than usual pores, and means, for example, a structure having split gaps having an average length from 1 μm to 100 μm and an average width from 0.1 μm to 10 μm. The structure allows a separation membrane having high strength while maintaining the permeation performance of the separation membrane to be prepared.

The separation active layer is formed on the branch-type structure layer to provide an external appearance of the hollow fiber separation membrane and substantially separate a solid content included in water to be treated from water, and any separation active layer may be used as long as the separation active layer is a typical separation active layer having the purpose in the art, but it is possible to preferably have a form in which the separation active layer is stacked on the branch-type structural layer in order to maintain strength, permeation performance, a rejection ratio, etc., at a high level, and more preferably have a form in which a plurality of pores having a size from 0.001 μm to 0.1 μm is formed.

Meanwhile, the thermally-induced phase separation method or the modified thermally-induced phase separation method, which is a method of forming piles of an aggregate form that constitutes the support layer, is not particularly limited as long as the method is a thermally-induced phase separation method or a modified thermally-induced phase separation method, which is usually used in the art, but for example, the thermally-induced phase separation method means preparing a separation membrane by bringing a polymer solution that is dissolved at high temperature into contact with a medium at low temperature to generate the liquid-solid phase separation and coagulation.

As a preferred example thereof, in order to constitute a support layer having the structure, it is possible to constitute a spinning solution with 20 wt % to 60 wt % of the PVDF contains amphiphilic polymers, which are a thermosetting resin, 30 wt % to 50 wt % of a poor solvent, 0.1 wt % to 10 wt % of an organic additive, 0.1 wt % to 20 wt % of an inorganic additive, and 0.1 wt % to 5 wt % of a non-solvent, based on the total weight of the spinning solution, by using the PVDF that contains the amphiphilic polymer.

As another preferred example thereof, in order to constitute a support layer having the structure, it is possible to constitute a spinning solution with 20 wt % to 60 wt % of the PVDF containing amphiphilic polymers, which are a thermosetting resin, 30 wt % to 50 wt % of a poor solvent, 0.1 wt % to 10 wt % of an organic additive, and 0.1 wt % to 5 wt % of a non-solvent, based on the total weight of the spinning solution, by using the PVDF that contains the amphiphilic polymers.

As a yet another preferred example thereof, in order to constitute a support layer having the structure, it is possible to constitute a spinning solution with 20 wt % to 60 wt % of the PVDF containing amphiphilic polymers, which are a thermosetting resin, 30 wt % to 50 wt % of a poor solvent, 0.1 wt % to 10 wt % of an organic additive, 0.1 wt % to 20 wt % of an inorganic additive, 0.1 wt % to 5 wt % of a non-solvent, and 0.01 wt % to 1 wt % of a surfactant, based on the total weight of the spinning solution, by using the PVDF that contains the amphiphilic polymers.

As a still another example thereof, in order to constitute a support layer having the structure, it is possible to constitute a spinning solution with 20 wt % to 50 wt % of the PVDF containing an amphiphilic polymer, which is a thermosetting resin, 30 wt % to 50 wt % of a poor solvent, 1 wt % to 20 wt % of a good solvent, 0.1 wt % to 10 wt % of an organic additive, 0.1 wt % to 20 wt % of an inorganic additive, and 0.1 wt % to 5 wt % of a non-solvent, based on the total weight of the spinning solution, by using the PVDF that contains the amphiphilic polymers.

At this time, water, ethylene glycol, diethylene glycol, or a mixture thereof is preferably used as the non-solvent, and sodium dodecyl sulfate, a straight-chain alkyl sulfonate, or a mixture thereof is preferably used as the surfactant.

Furthermore, a polyvinyl pyrrolidone having a weight average molecular weight from 10,000 Da to 90,000 Da, a polyethylene glycol having a weight average molecular weight from 200 Da to 1,000 Da, maleic anhydride, or polyvinyl alcohol may be used as the organic additive, and lithium chloride, sodium chloride, and calcium chloride may be used as the inorganic additive.

The spinning solution in the present invention is preferably prepared at a temperature from 80° C. to 200° C. A uniformly mixed spinning solution is prepared without forming a precipitate or a floating material by maximally dissolving the PVDF-based resin and the amphiphilic polymer components which are main components.

In order to prepare a general hollow fiber membrane in the present invention, a hollow fiber membrane may be prepared by a relatively simple method. As an example thereof, it is possible to use one selected from the group consisting of dimethylformamide, N-methylpyrrolidone, dimethyl sulfoxide, and dimethyl acetamide, or a mixed organic solvent of two or more thereof as the solvent used when the spinning solution of the hollow fiber membrane is prepared. The prepared spinning solution is subjected to a step of spinning through a dual nozzle that is maintained at a temperature from 80° C. to 200° C. At this time, the spun hollow fiber membrane is prepared as a porous hollow fiber separation membrane while being precipitated in an external coagulant and coagulated. The dual nozzle used herein determines the internal and external diameters of the hollow fiber, the diameter of the dual nozzle is determined for preparing an optimal hollow fiber according to the dope solution, and then the fiber is spun.

The coagulant used in the coagulation process of the present invention allows pores to be uniformly formed by maintaining the coagulant at the temperature from 20° C. to 50° C., preferably at normal temperature. At this time, water is preferably used as the coagulant, and in addition to water, it is possible to use a solution in which one or more organic solvents selected from the group consisting of dimethylformamide, N-methylpyrrolidone, dimethyl sulfoxide, and dimethyl acetamide are mixed with water.

Further, in the preparing of the porous hollow fiber separation membrane, washing and drying processes may be further performed in order to remove a solvent remaining in and out of the formed hollow fiber PVDF membrane.

In the washing process, water is preferably used, and the time for washing is not particularly limited, but the hollow fiber PVDF separation membrane is prepared by performing washing for at least one day or more and 5 days or less.

As described above, the PVDF hollow fiber separation membrane prepared according to the present invention is prepared as a separation membrane in the form of a porous hollow fiber having hydrophilicity and alkali resistance.

As an exemplary embodiment of a hollow fiber separation membrane having a preferably specific form according to the present invention, a process of preparing a separation membrane using a triple nozzle may be exemplified as follows.

<Process of Preparing Spinning Solution>

As the thermoplastic resin that forms the hollow fiber separation membrane, a thermosetting resin, in which amphiphilic polymers have been introduced into a PVDF, is used, and a solution obtained by dissolving an inorganic additive, an organic additive, a surfactant, etc., in appropriate good solvent, poor solvent, non-solvent, or one or more thereof is mixed with the thermosetting resin. The good solvent is preferably maintained at 50° C. or less. At this time, the mixture needs to be uniformly mixed such that a precipitate or a floating material is not present at a temperature of 120° C. or more. The spinning solution is preferably prepared at 120° C. to 200° C., and is also subjected to a defoaming process in order to remove bubbles present in the solution. In general, a hollow fiber separation membrane is formed by coagulating the spinning solution at a temperature of 120° C. or less, or a hollow fiber separation membrane is formed by phase separation when the spinning solution is in contact with a non-solvent at a temperature of 120° C. or less.

<Process of Preparing Hollow Forming Agent>

A hollow forming agent is prepared by usually using water or ethylene glycol as the non-solvent, and one or more selected from, for example, dimethyl pyrrolidone or dimethyl acetate, dimethyl formamide, and dimethyl sulfuroxide as a mixed good solvent when the solvents are mixed, and maintaining a ratio of the good solvent to the non-solvent as from 2 to 8 to from 8 to 2 at normal temperature, the hollow forming agent is defoamed, and the temperature is maintained at 1° C. to 80° C. when the hollow forming agent is transferred to a triple spinning nozzle.

<Process of Preparing Re-Dissolution Solvent>

The good solvent is used alone at normal temperature, or a mixture with a ratio of the good solvent to the non-solvent being from 9 to 1 to from 6 to 4 is prepared and then defoamed, the temperature is maintained at 1° C. to 80° C. when the mixture is transferred to the triple spinning nozzle, or acetone is used alone when used as a re-dissolution solvent, and the temperature is maintained at −10° C. to 40° C. when the re-dissolution solvent is transferred to the triple spinning nozzle and then discharged into a coagulation bath.

<Preparation of Hollow Fiber Separation Membrane>

A hollow fiber separation membrane, which has a support layer having a pile structure, a support layer for a branch-type separation active layer, and a 5-micron or less separation active layer, is prepared by simultaneously discharging the spinning solution, the hollow forming agent, and the re-dissolution solvent, which have been prepared above, as a coagulant using a triple spinning nozzle. At this time, the coagulant used in the coagulation process consists of pure water that is a non-solvent, or a non-solvent that contains a predetermined amount of a good solvent, and an internal surface having macropores begins to be formed therein by the hollow forming agent that is in contact therein while the spinning solution is spun. In the case of an external surface, quenching is generated on the surface thereof by the re-dissolution solvent and is instantly coagulated, and then re-dissolution occurs due to the characteristics of the good solvent. While the hollow fiber separation membrane in which re-dissolution has occurred on the surface is being immersed in a coagulation bath, re-dissolution occurs on the surface of the hollow fiber separation membrane, and thus the polymer that is maintained in a liquid phase is re-coagulated by the contact with the non-solvent, and then a support layer for a branch-type separation active layer and a separation active layer are formed.

<Washing Process>

In order to remove organic materials that include a solvent remaining in and out of the hollow fiber separation membrane that has been transferred from the coagulant to the atmosphere, a washing process may be further included. Water is preferably used as a washing solution, and the washing time is not particularly limited, but at least one day or more and 5 days or less are preferred.

As another preferred exemplary embodiment of the present invention, a hollow fiber separation membrane may be prepared using a dual nozzle.

At this time, the hollow fiber separation membrane may be prepared by discharging an internal coagulant therein from the dual nozzle, discharging the spinning solution as in the triple nozzle externally to be coagulated, continuously allowing the spinning solution to pass through a good solvent, and then allowing the spinning solution to pass through a non-solvent. Here, the good solvent is preferably maintained within a temperature range from 5° C. to 150° C.

According to the present invention, the PVDF hollow fiber separation membrane prepared by various methods as described above may be prepared so as to have a structure of a hollow fiber membrane having an internal diameter from 0.10 mm to 5.0 mm and an external diameter from 0.15 mm to 6.0 mm.

The thus-prepared hollow fiber separation membrane according to the present invention is characterized by having a contact angle from 15 degrees to 44 degrees and a pure water permeability from 800 to 1,200 (1/m² hr). The contact angle and the pure water permeability tend to decrease during a post-treatment process in order to improve physical properties of the PVDF hollow fiber separation membrane, and the present invention is prepared without a separate post-treatment process and thus is prepared while retaining the contact angle and pure water permeability.

The PVDF hollow fiber separation membrane according to the present invention is prepared while physical properties have been improved by introducing amphiphilic polymers in the preparation process without being subjected to any post-treatment for separately improving physical properties after the hollow fiber separation membrane is prepared, as described above, and thus the preparation process is simple and the separation membrane may be economically prepared, and may be prepared as a hollow fiber separation membrane having excellent physical properties while retaining various physical properties, such as contact angle, pure water permeability, etc., which have been initially obtained during the preparation process.

As described above, the PVDF hollow fiber separation membrane prepared according to the present invention is prepared by a method of simply and economically preparing a PVDF hollow fiber separation membrane having excellent hydrophilicity and alkali resistance by introducing a solution, in which an amphiphilic polymers that include hydrophilicity and hydrophobicity are mixed, into a solution that contains the PVDF resin.

Hereinafter, the present invention will be described in detail with reference to Examples. The following Examples are provided only for illustrating the present invention, and the scope of the present invention is not limited by the following Examples.

### Example 1

A spinning solution was prepared by adding 5 parts by weight of poly(ethylene glycol)behenyl ether methacrylate (Aldrich Corp., Mw: 50,000) as a polyethylene glycol-methacrylate-based compound, which was a first additive, and 5 parts by weight of poly(1-vinyl pyrrolidine-co-2-dimethylamino ethylmethacrylate (Aldrich Corp., Mw: 50,000) as a polypyrrolidone-methacrylate-based compound, which was a second additive, to a mixture that includes 70 parts by weight of N,N-dimethylacetamide (DMAC) as a solvent and 20 parts by weight of polyvinylidene fluoride (PVDF) (Solvay Corp., Mw: 300,000) as a polymer so as to prepare a thermosetting resin.

Bubbles contained in the spinning solution prepared above were removed using a vacuum pump, and then the spinning solution was transferred to a dual nozzle, which was maintained at 90° C., using a gear pump. Thereafter, a hollow fiber membrane was prepared by continuously precipitating the spinning solution in water, which was an external coagulant, at normal temperature.

At this time, the amount of the solution discharged was 1.5 cc/min, and subsequently, the hollow fiber membrane that had passed through the external coagulant was continuously transferred to the atmosphere for 30 seconds, and then the hollow fiber membrane was immediately wound through a winding bobbin that was immersed in water by approximately ½, and the hollow fiber membrane was washed in a water washing bath for 96 hours in order to remove more organic solvents remaining.

The completely washed hollow fiber membrane was immersed in 50 wt % of a glycerin aqueous solution for 24 hours and then dried at normal temperature, and the PVDF hollow fiber membrane had a structure of a hollow fiber membrane having an internal diameter of 0.7 mm and an external diameter of 1.3 mm, and the result of evaluating physical properties is specified in the following Table 1.

### Example 2

The experiment was performed in the same manner as in Example 1, except that 10 wt % of poly(ethylene glycol)behenyl ether methacrylate (Aldrich Corp., Mw: 50,000), which was the first additive, and 10 wt % of poly(1-vinylpyrrolidine-co-2-dimethylamino ethylmethacrylate) (Aldrich Corp., Mw: 50,000), which was the second additive, were added thereto, and the result of evaluating physical properties is specified in the following Table 1.

### Example 3

The experiment was performed in the same manner as in Example 1, except that 20 wt % of poly(ethylene glycol)behenyl ether methacrylate (Aldrich Corp., Mw: 50,000), which was the first additive, and 20 wt % of poly(1-vinylpyrrolidine-co-2-dimethylamino ethylmethacrylate) (Aldrich Corp., Mw: 50,000), which was the second additive, were added thereto, and the result of evaluating physical properties is specified in the following Table 1.

### Example 4

The experiment was performed in the same manner as in Example 1, except that 30 wt % of poly(ethylene glycol)behenyl ether methacrylate (Aldrich Corp., Mw: 50,000), which was the first additive and 30 wt % of poly(1-vinylpyrrolidine-co-2-dimethylamino ethylmethacrylate) (Aldrich Corp., Mw: 50,000), which was the second additive, were added thereto, and the result of evaluating physical properties is specified in the following Table 1.

### Comparative Example 1

In order to prepare an asymmetric hollow fiber membrane that was a general separation membrane, a support layer was prepared using a thermally-induced phase separation method and in preparing a separation active layer by dissolving a part of a spinning solution and then re-coagulating the spinning solution in order to form the support layer, a uniform spinning solution was prepared by charging 44 parts by weight of γ-butyrolactone, which was a poor solvent, into a dissolution bath, raising the temperature to 50° C., adding 3 parts by weight of polyvinyl pyrrolidone having a weight average molecular weight of 19,000 Da, which was an organic additive, thereto, adding 3 parts by weight of lithium chloride as an inorganic additive and 3 parts by weight of diethylene glycol, which was a non-solvent, thereto, raising the temperature to 150° C., slowly adding 47 parts by weight of polyvinylidene fluoride (PVDF) (Solvay Corp., Mw: 300,000) thereto, and then raising the temperature to 180° C. The spinning solution was allowed to flow into a middle nozzle equipped with a triple tube at 150° C., an internal coagulant with dimethyl acetate and water being mixed in a ratio of 6 to 4 at normal temperature was allowed to flow thereinto to form a hollow, and dimethyl acetate was allowed to flow externally at 5° C. The three solutions were all spun into a coagulating bath consisting of water at 5° C. and finally coagulated. Dimethyl acetate flowing externally was very iced compared to the polymer solution and thus coagulated the surface of the polymer solution, and since dimethyl acetate is a good solvent, re-dissolution occurs very thinly on the coagulated surface and dimethyl acetate was coagulated again in a coagulation bath, and thus a very dense separation active layer was formed with a layer having a branch-type structure. The prepared hollow fiber membrane had an internal diameter of 0.7 mm and an external diameter of 1.3 mm.

### Comparative Example 2

The experiment was performed in the same manner as in Example 1, except that poly(ethylene glycol)behenyl ether methacrylate (Aldrich Corp., Mw: 50,000), which was the first additive, and poly(1-vinylpyrrolidine-co-2-dimethylamino ethylmethacrylate) (Aldrich Corp., Mw: 50,000), which was the second additive, were not added thereto, and the result of evaluating physical properties is specified in the following Table 1.

### Experimental Example

Physical properties were evaluated on each of the hollow fiber membranes which had been prepared in Examples 1 to 4 and Comparative Examples 1 to 2, and the results are specified in the following Table 1.

Each of the experiments of evaluating physical properties was performed as follows.

1. Evaluation of Hydrophilicity

1) Evaluation of contact angle: the contact angle was evaluated 10 seconds after water drops were dropped on the surface of the hollow fiber membrane using a contact angle measuring equipment (Phx 300, SEO, Korea). The better the hydrophilicity is, the more likely the contact angle decreases.

2) Measurement of pure water permeability: For the separation membrane prepared, the amount of water permeated was measured by supplying pure water at normal temperature to one side surface of the separation membrane at 2.0 atm using a dead-end method and then denoted in terms of a permeated amount per unit time, unit membrane area, and unit pressure. The higher the pure water permeability is, the more likely the separation membrane exhibits excellent hydrophilicity.

2. Measurement of Rejection Ratio

A 1,000 ppm aqueous solution was prepared by dissolving bovine serum albumin (BSA; Aldrich Corp., Mw 66,000) in pure water at normal temperature. As an aspect of the separation membrane prepared above, the concentrations of an aqueous solution permeated by supplying the aqueous solution at a pressure of 2.0 kg/cm² and BSA dissolved in original water that had been initially supplied were measured using an ultraviolet spectrophotometer (Varian Corp., Cary-100). Thereafter, the rejection ratio was determined by converting the relative ratio of the absorption peak measured at a wavelength of 278 nm into a percentage using the following Equation 1.

[Equation 1]

Rejection ratio (%)=(Concentration of original solution−Concentration of permeated solution)÷Concentration of original solution×100

3. Evaluation of Alkali Resistance (Measurement of Rate of Change in Tensile Strength)

A 5% NaOH solution was prepared, and the hollow fiber membrane was immersed in the solution for 12 hours using a constant temperature bath at 90° C. and then washed with pure water, and dried at normal temperature for 24 hours, and then the rate of change in strength with respect to chemical damage for alkali in the hollow fiber membrane due to change in strength was compared by measuring the tensile strength of the hollow fiber membrane.

TABLE 1

| | | | | | Reduction |
|---|---|---|---|---|---|
| | Contact | Pure water | | Tensile | rate in |
| Classi- | Angle | permeability | Rejection | strength | tensile |
| fication | (°) | (l/m² hr) | ratio (%) | (MPa) | strength (%) |
| Example 1 | 33 | 843 | 99.0 | 55.1 | — |
| Example 2 | 30 | 845 | 99.0 | 55.0 | 0.181 |
| Example 3 | 25 | 900 | 99.0 | 55.0 | 0.181 |
| Example 4 | 23 | 920 | 98.8 | 55.0 | 0.181 |
| Comparative | 60 | 125 | 99.0 | 55.1 | — |
| Example 1 | | | | | |
| Comparative | 63 | 120 | 99.0 | 55.1 | — |
| Example 2 | | | | | |

As confirmed in Table 1, as a result of comparing and reviewing physical properties in Comparative Examples 1 and 2, which are general PVDF hollow fiber separation membranes which do not use additives 1 and 2 (amphiphilic polymers) which are used in the Examples of the present invention, with physical properties in Examples 1 to 4, an experimental result was derived in a direction that when the amounts of additives 1 and 2 were increased, the contact angle was decreased, that is, the hydrophilic tendency increased and accordingly, pure water permeability simultaneously increased.

Furthermore, as a result of measuring the tensile strength after immersion in the alkali solution in order to evaluate alkali resistance, the tensile strength was as good as that in the Comparative Examples, and thus it was confirmed that alkali resistance was also excellent.

When the experimental results are collected and analyzed, the hollow fiber separation membrane of the present invention has significantly excellent contact angle and pure water permeability compared to those in the hollow fiber separation membrane in the related art, which means that hydrophilicity has been significantly improved. Excellent physical properties were also exhibited in terms of alkali resistance, and thus it was confirmed that the hollow fiber separation membrane may exhibit excellent performance when applied to various separation membranes

### INDUSTRIAL APPLICABILITY

The PVDF hollow fiber separation membrane according to the present invention may be applied to an ultrafiltration membrane or a microfiltration membrane, and may be applied to various fields of water treatment, such as waste water treatment or preparation of industrial water, pretreatment in the desalination process of sea water, etc.

In particular, the separation membrane of the present invention has excellent hydrophilicity, alkali resistance, chemical resistance, etc., and thus may be applied to various industrial fields such as food field, medicine field, water purification facilities, separation of microorganism from fermented solution, purification of proteins, etc.

1. A polyvinylidene fluoride hollow fiber separation membrane that consists of a thermoplastic resin, which contains from 2 to 50 parts by weight of one or more selected from polyethylene glycol-methacrylate-based and polyvinylpyrrolidone-methacrylate-based amphiphilic polymers and having a weight average molecular weight from 10,000 to 200,000, based on 100 parts by weight of a polyvinylidene fluoride resin, and has a porous hollow fiber structure.

2. The polyvinylidene fluoride hollow fiber separation membrane of claim 1, wherein the polyvinylidene fluoride resin has a weight average molecular weight (Mw) from 50,000 to 500,000.

3. The polyvinylidene fluoride hollow fiber separation membrane of claim 1, wherein the polyvinylidene fluoride resin is a copolymerization polymer that contains 30 mole % or more of a vinylidene fluoride homopolymer or vinylidene fluoride.

4. The polyvinylidene fluoride hollow fiber separation membrane of claim 1, wherein the hollow fiber has an internal diameter from 0.10 mm to 5.0 mm and an external diameter from 0.15 mm to 6.0 mm.

5. The polyvinylidene fluoride hollow fiber separation membrane of claim 1, wherein the hollow fiber has a contact angle from 15 degrees to 44 degrees and a pure water permeability from 800 to 1,200 (1/m² hr).

6. The polyvinylidene fluoride hollow fiber separation membrane of claim 1, wherein piles of a plurality of irregular aggregate forms are connected with each other inside the separation membrane, gaps split between piles and piles have an average length from 1 μm to 100 μm, a support layer having an amorphous structure, which has macropores having an average width from 0.1 μm to 10 μm, is formed, and a branch-type structure layer and a separation active layer are sequentially formed on the support layer.

7. The polyvinylidene fluoride hollow fiber separation membrane of claim 6, wherein the support layer is composed of the form of aggregates that are formed by a thermally-induced phase separation method or a modified thermally-induced phase separation method.

8. The polyvinylidene fluoride hollow fiber separation membrane of claim 6, wherein the branch-type structural layer is composed of a plurality of pores having a size from 5 μm to 100 μm.

9. The polyvinylidene fluoride hollow fiber separation membrane of claim 6, wherein a separation active layer is composed of a plurality of pores having a size from 0.001 μm to 0.1 μm.

10. The polyvinylidene fluoride hollow fiber separation membrane of claim 6, wherein the separation active layer has a thickness from 0.1 μm to 5 μm.

11. A method of preparing a polyvinylidene fluoride (PVDF) hollow fiber separation membrane, the method comprising:
preparing a spinning solution by using a thermoplastic resin that includes from 2 to 50 parts by weight of one or more selected from polyethylene glycol-methacrylate-based and polyvinylpyrrolidone-methacrylate-based amphiphilic polymers and having a weight average molecular weight from 10,000 to 200,000, based on 100 parts by weight of a PVDF resin;
spinning the spinning solution through a nozzle for preparing a hollow fiber; and
preparing a porous hollow fiber by subjecting the spinning solution to a coagulation process.

12. The method of claim 11, wherein a polyvinylidene fluoride resin having a weight average molecular weight (Mw) from 50,000 to 500,000 is used as the polyvinylidene fluoride resin.

13. The method of claim 11, wherein the temperature is maintained at 80° C. to 200° C. while preparing the spinning solution.

14. The method of claim 11, wherein the coagulant used in the coagulation process is water, or a mixed solution between water and one or more organic solvents selected from the group consisting of dimethylformamide, N-methylpyrrolidone, dimethyl sulfoxide, and dimethyl acetamide.

15. The method of claim 11, wherein the coagulant used in the coagulation process is maintained at a temperature from 20° C. to 50° C.

16. The method of claim 11, further comprising: after preparing the spinning solution, discharging an internal coagulant therein from a triple nozzle, discharging a good solvent at a temperature of 50° C. or less externally, and discharging a thermosetting resin solution from a nozzle between the inside and the outside.

17. The method of claim 11, further comprising: after preparing the spinning solution, discharging an internal coagulant therein from a dual nozzle, discharging the thermosetting resin solution externally to be coagulated, continuously allowing the thermosetting resin solution to pass through a good solvent, and then allowing the thermosetting resin solution to pass through a non-solvent.

18. The method of claim 11, wherein the spinning solution is composed of 20 wt % to 60 wt % of the thermosetting resin, 30 wt % to 50 wt % of a poor solvent, 0.1 wt % to 20 wt % of one or more of an organic additive and an inorganic additive, and 0.1 wt % to 5 wt % of a non-solvent, based on the total weight of the spinning solution.

19. The method of claim 11, wherein the spinning solution is composed of 20 wt % to 60 wt % of the thermosetting resin, 30 wt % to 50 wt % of a poor solvent, 0.1 wt % to 10 wt % of one or more of an organic additive, and 0.1 wt % to 5 wt % of a non-solvent, based on the total weight of the spinning solution.

20. The method of claim 11, wherein the spinning solution is composed of 20 wt % to 60 wt % of the thermosetting resin, 30 wt % to 50 wt % of a poor solvent, 0.1 wt % to 20 wt % of one or more of an organic additive and an inorganic additive, 0.1 wt % to 5 wt % of a non-solvent, and 0.01 wt % to 1 wt % of a surfactant, based on the total weight of the spinning solution.
